(19) United States
(12) Patent Application Publication
(10) Pub. No.: US 2001/0015605 A1
(43) Pub. Date: Aug. 23, 2001

(54) Carbon film, field emission cathode comprising the carbon film, and method of manufacturing the carbon film

(76) Inventor: Masayuki Yoshiki, Tokyo (JP)

Correspondence Address: SUGHRUE, MION, ZINN, MACPEAK & SEAS, 2100 Pennsylvania Avenue, N.W., Washington, DC, 20037-3202, US

(21) Appl. No.: 09/784,125

(22) Filed: Feb. 16, 2001

(30) Foreign Application Priority Data
Feb. 18, 2000 (JP) 105657/2000

(51) Int. Cl. H01J 1/30; H01J 9/02

(52) U.S. Cl. 313/310; 427/77; 445/51

(57) ABSTRACT

In a field emission film used for a field emission cathode, a filamentous structure layer is formed in the vicinity of tops of acicular projections to emit electrons. The filamentous structure layer serves to remarkably increase emission points and, as a result, to improve an emission current density. The filamentous structure layer may be composed of a carbon and is obtained by carrying out plasma processing within a hydrogen gas and/or an oxygen gas for a long time.

### BACKGROUND OF THE INVENTION

This invention relates to a field emission cathode which is capable of improving an emission current density and a method of manufacturing the same.

A recent attention has been focused on a field emission cathode which serves as an electron gun in a flat type display and which has a plurality of cone-shaped emitters surrounded by gate electrodes with space gaps left between the emitters and the gate electrodes. Specifically, such a field emission cathode usually emits electrons from each tip of cone-shaped emitters towards an anode by electric field generated between the emitters and .the gate electrodes. With this structure, it is possible to accomplish low voltage drive and high integration by narrowing the space gaps between the emitters and the gate electrodes and by finely forming the emitters.

Recently, proposals have been offered about a field emission cathode which uses, as the emitters, carbon films of a diamond-based, such as diamond, diamond-like carbon, or the like that can emit electrons by impressing a low voltage. It is to be noted that such a field emission cathode with the carbon film of the diamond-based enables electron emissions from a flat plane. In addition, it is possible to achieve an improvement of low voltage drive and current controllability by making the gate electrodes close to the emitters so as to get out the electrons from the emitters. Furthermore, it has been expected that a field emission cathode of the above-mentioned type makes it possible to simplify a manufacturing process and to facilitate manufacture of a big size display.

For example, Japanese Patent Publication No. 2742749 discloses a field emission cathode that has emitters of a diamond-based carbon film. Specifically, the field emission cathode includes a conductive/semi-conductive underlying layer, a plurality of conical projections composed of the same material as the underlying layer, and a diamond film covered on each top of the conical projections. Each diamond film is formed by diamond grains.

With this structure, the diamond films are operated as emitters and can concentrate an electric field on each top of the conical projections, which causes an emission current to occur at a low voltage.

Herein, it is to be noted that the above-mentioned field emission cathode emits the electrons from only each top of the conical projections. In other words, the top of the control projections alone serve as emission points, respectively, while the remaining portions of the control projections never contribute to the emissions. This shows that a rate of an emission area-to-a total emitter area becomes very small and, as a result, an emission current density is very low.

### SUMMARY OF THE INVENTION

It is an object of this invention to provide a field emission cathode which is capable of widening an emission point area and, thereby, enables an increase of an emission current density.

It is another object of this invention to provide a carbon film which is useful for a field emission cathode of the type described and which can serve to increase the emission current density.

It is still another object of this invention to provide a method of manufacturing a field emission cathode of the type described.

According to this invention, a carbon film comprises an acicular carbon layer and a filamentous carbon layer which is covered on the acicular carbon layer. The acicular carbon layer comprises a plurality of conical and/or pyramidal shape projections. On the other hand, the filamentous carbon layer is formed by at least one carbon filament that is not greater than 10 nm in filament width.

According to another aspect of this invention, a film is for use in emitting electrons. The film comprises a filamentous layer formed by a plurality of filaments. The filamentous layer is attached to an acicular layer comprising a plurality of acicular projections. The acicular projections have conical and/or pyramidal shapes.

According to still another aspect of this invention, a field emission cathode comprises an emitter for emitting electrons. The emitter comprises a carbon film which has a composite layer structure which has an acicular carbon layer and a filamentous carbon layer which is covered on the acicular carbon layer.

According to yet another aspect of this invention, a method is for use in manufacturing a composite carbon film. The method comprises the steps of: depositing a carbon film, forming an acicular carbon layer composed of acicular projections on a surface of the carbon film, and changing the acicular carbon layer into a filamentous carbon layer comprising at least one filament to form the composite carbon film. The forming step comprises the step of carrying out plasma processing of the carbon film within a hydrogen gas to form the acicular carbon layer. The changing step comprises the step of: carrying out plasma processing the acicular carbon layer within a hydrogen gas to form the filamentous carbon layer attached to the acicular carbon layer and to thereby form the composite carbon film.

Alternatively, the forming step may comprise the step of carrying out plasma processing of the carbon film within a hydrogen gas and an oxygen gas to form the acicular carbon layer while the changing step comprises the step of carrying out plasma processing the acicular carbon layer within a hydrogen gas to form the filamentous carbon layer attached to the acicular carbon layer and to thereby form the composite carbon film.

According to this invention, a method is for use in manufacturing a field emission cathode which has an emitter. The method comprises the steps of depositing a carbon film, forming an acicular carbon layer composed of acicular projections on a surface of the carbon film, and changing the acicular carbon layer into a filamentous carbon layer comprising at least one filament to form the emitter.

### BRIEF DESCRIPTION OF THE DRAWING

FIG. 1 shows a sectional view of a conventional field emission cathode;

FIG. 2 shows a partial sectional view of a carbon film according to a first embodiment of this invention;

FIG. 3 shows a photograph of the carbon film which is illustrated in FIG. 1 and which is observed by an SEM;

FIGS. 4A, 4B, 4C, and 4D show process diagrams for use in describing a method of manufacturing the carbon film illustrated in FIG. 3;

FIG. 5 shows an SEM photograph of a carbon film according to a second embodiment of this invention;

FIG. 6 shows another SEM photograph of a carbon film according to a modification of this invention;

FIG. 7 shows a sectional view of a field emission cathode according to a third embodiment of this invention; and

FIGS. 8A, 8B, and 8C show process diagrams for use in describing a method of manufacturing the field emission cathode illustrated in FIG. 7.

### DESCRIPTION OF THE PREFERRED EMBODIMENTS

Referring to FIG. 1, description will be made about a conventional field emission cathode which is substantially equivalent to that mentioned in the preamble of the instant specification. As shown in FIG. 1, the field emission cathode is formed by a conical projection 101 selectively formed on and protruded from a layer 100 of a conductive/semi-conductive material. The illustrated conical projection 101 is composed of the same material as the layer 100. On a top end of the conical projection 101, is formed a diamond film 103 of diamond grains 102. The illustrated field emission cathode has a disadvantage as mentioned before.

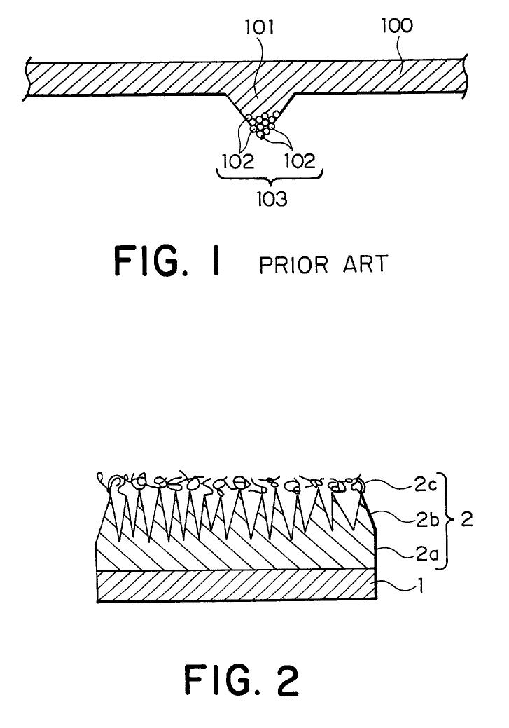

Referring to FIG. 2, a field emission cathode according to a first embodiment of this invention has a substrate 1 and a carbon film 2 formed on the substrate 1. As will become clear later, the illustrate field emission cathode is specified by the carbon film 2 which is effective to increase emissions of the electrons. Specifically, the illustrated carbon film 2 comprises a lowermost or bottom carbon layer 2a and an intermediate carbon layer 2b of an acicular or conical structure attached to the bottom carbon layer 2a. The intermediate carbon layer 2b is formed by a plurality or a great number of acicular projections. Moreover, the respective acicular projections of the intermediate carbon layer 2b are covered with an uppermost carbon layer 2c composed of filaments which are extended from tops of the respective acicular projections and which are formed by thin carbon threads. Thus, the uppermost carbon layer 2c is given by an aggregation of the filaments covering the tops of the respective acicular projections like a cloud. In this connection, the uppermost carbon layer 2c may be called filamentous carbon layer hereinafter.

As mentioned before, the illustrated intermediate carbon layer 2b is formed by the acicular projections which have sharp tops like needles, bottom widths not wider than 200 nm, and heights not higher than 1 μm. Each of the acicular projections may be either a conical shape or a pyramidal shape. A density of the acicular projections may fall within a range between 25/μm² and 1,000,000/μm².

On the other hand, the filamentous carbon layer 2c is formed by the aggregation of at least one carbon filament that is thinner than 10 nm. The carbon filaments may have a needle-like structure or an entangled structure like fluff.

The filamentous carbon layer 2c can emit electrons from every place of the whole of the thin carbon filaments by giving a low electric voltage. As illustrated in FIG. 2, the acicular projections 2b are covered with such a filamentous carbon layer 2c. This shows that emission points which are defined by the filamentous carbon layer 2c are extremely increased, as compared with the conventional field emission cathode. In other words, the emission points are distributed over a very wide area in the field emission cathode illustrated in FIG. 2. In consequence, the emissions become uniform and the emission current density can be improved.

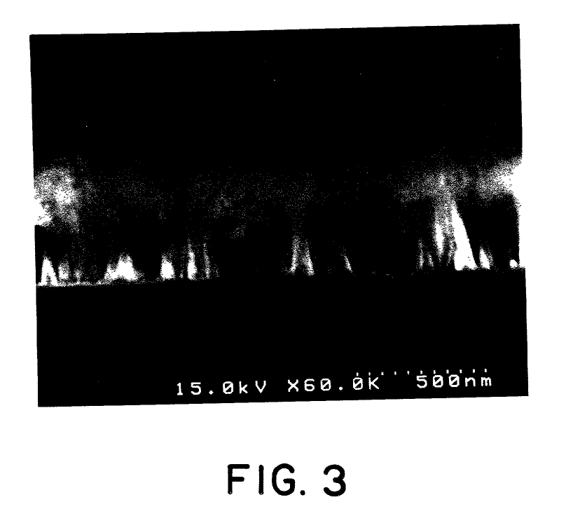

Referring to FIG. 3, a specific example of the field emission cathode according to this invention is shown by an SEM (scanning electron microscope) photograph. It is found out by this photograph that a carbon film according to the specific field emission cathode is specified by a plurality of the acicular projections standing on a lowermost layer and a filamentous carbon layer that is formed by an aggregation of a lot of filaments. Each filament is very thin, as illustrated in FIG. 3.

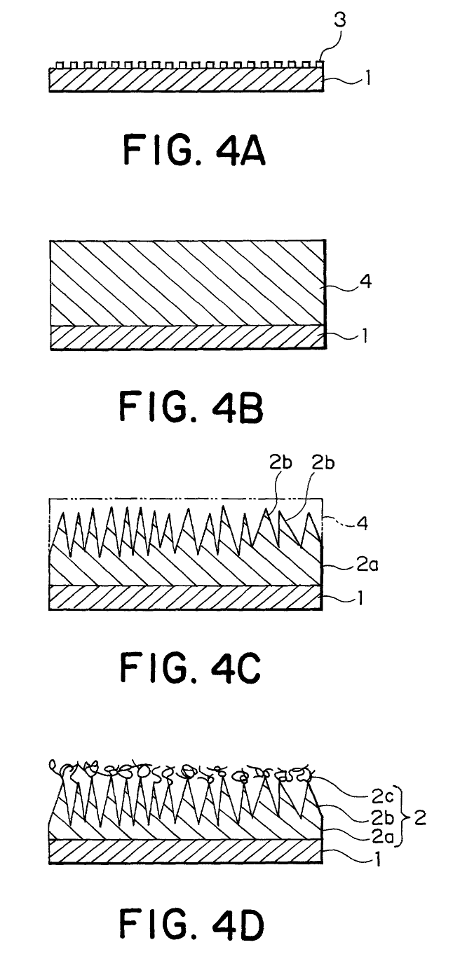

Referring to FIGS. 4A to 4C, description will be made about a method of manufacturing a field emission cathode, as shown in FIGS. 2 and 3. At first, a substrate 1 is prepared which serves as a cathode electrode and which may be formed by a conductive or a semi-conductive material. Diamond grains 3 are selectively and sparsely attached to a principal surface of the substrate 1. Such diamond grains act as nuclei on growing a carbon film according to this invention.

Herein, the substrate 1 with the diamond grains 3 can be prepared by soaking the substrate 1 into an ethyl alcohol solution which includes diamond grains not greater in grain size than 1 μm and by subjecting the substrate 1 to a ultrasonic process. Thus, the diamond grains 3 are sparsely distributed on and attached to the principal surface of the substrate 1, as illustrated in FIG. 4A.

Subsequently, a carbon layer 4 is deposited, as shown in FIG. 4B on the above-mentioned substrate 1 to a thickness of 500 nm by a CVD method of a thermal filament type(will be called a thermal filament CVD hereinafter). Specifically, the deposition is made by using a mixed gas of methane and hydrogen with a concentration ratio of the methane in the mixed gas kept at 1% and with a total gas pressure kept at 2.6×10³ Pa (20 Torr) and by maintaining the substrate I at a temperature of about 850° C.

Next, the carbon layer 4 deposited on the substrate 1 is subjected to surface processing for two hours within electron cyclotron resonance (ECR) plasma. The ECR plasma is generated within a hydrogen gas kept at a pressure between 1.33×10⁻² and 1.33×10⁻¹ Pa (namely, 10⁻⁴ and 10⁻³ Torr), with a flux density kept between about 850 and 900 G, and with a microwave of about 2.5 GHz given. Power of such ECR plasma has power is about 500 W.

As a result, it has been found out that the carbon film 4 is roughened, as illustrated in FIG. 4C, to be shaped on an upper or surface portion into an acicular carbon layer 2b which has an acicular projection structure. A lower portion of the carbon film 4 underlying the acicular carbon layer 2b is kept unchanged and is left as a carbon layer 2a of a uniform structure and forms the intermediate carbon layer.

Thereafter, surface processing is carried out again within the ECR plasma under the same conditions for about two hours again. As a result, it has been found out that a filamentous carbon layer 2c is formed on the surface of the acicular carbon layer 2b, as shown in FIG. 4D. It has been confirmed that the filamentous carbon layer 2c is composed of an aggregation of very thin carbon filaments each of which has a diameter of about 1 nm. Thus, the illustrated carbon film 2 is obtained which has three layer structure composed of 2a, 2b, and 2c, as shown in FIG. 4D.

According to the inventor's experimental studies, it has been found out that the carbon film 4 deposited on the substrate 1 in the above-mentioned manner has uneven structures which include portions easily etched by the ECR plasma and the remaining portions hardly etched by the ECR plasma. This results in occurrence of the projections on the carbon film 4. In addition, further etching processing due to the ECR plasma brings about occurrence of the filaments on the tops of the projections, as shown in FIG. 4D.

With the above-mentioned method, it is possible to manufacture the field emission cathode which conducts emissions by impressing a low electric voltage and which is high at an emission current density because of a great number of emission points.

In the above-mentioned method of manufacturing the carbon film according to the embodiment of this invention, the process conditions may be changed so as to form the carbon film 2. In this case, the process conditions may be varied within ranges such that the substrate is kept at the temperature between 400 and 850° C., the ratio of the methane concentration is between 1% and 100%, and the total gas pressure is between 1.33×10² and 7.98×10³ Pa (namely, 1 to 60 Torr). This is because the plasma processing conditions of the hydrogen gas is varied with a variation of manufacturing conditions of the carbon film 2.

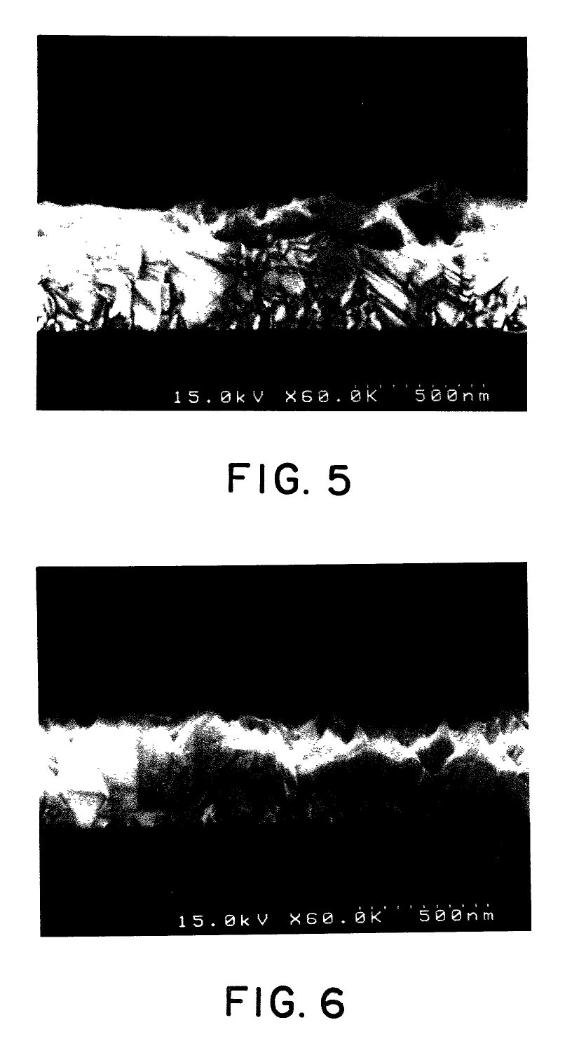

Referring to FIG. 5, a carbon film according to a second embodiment of this invention is specified by a photograph taken by an SEM. The carbon film shown in FIG. 6 is attained by processing a uniform carbon film within a hydrogen gas by the use of plasma as mentioned in conjunction with FIGS. 4A to 4D and by thereafter carrying out plasma processing in an oxygen gas to form the acicular carbon layer 2b (FIGS. 4A to 4D). Subsequently, the acicular carbon layer 2b is further subjected to plasma processing in hydrogen gas to form the filamentous carbon layer 2c on the acicular carbon layer 2b.

Referring to FIG. 6, another carbon film is shown which is obtained by the following processes. Specifically, after the plasma processing is carried out in the hydrogen gas in the above-mentioned manner, surface processing is executed for one hour within an oxygen gas kept at a pressure between 1.33×10⁻³ and 1.33×10¹ Pa (10⁵ to 10⁻³ Torr) under the ECR plasma of about 500 W generated by providing the magnetic flux density of about 850 to 900 G and by impressing a microwave of about 2.5 GHz. As a result, the acicular carbon layer is obtained as shown in FIG. 6 and is formed into the filamentous carbon layer by thereafter carrying out plasma processing for two hours within the hydrogen gas with the remaining conditions kept unchanged.

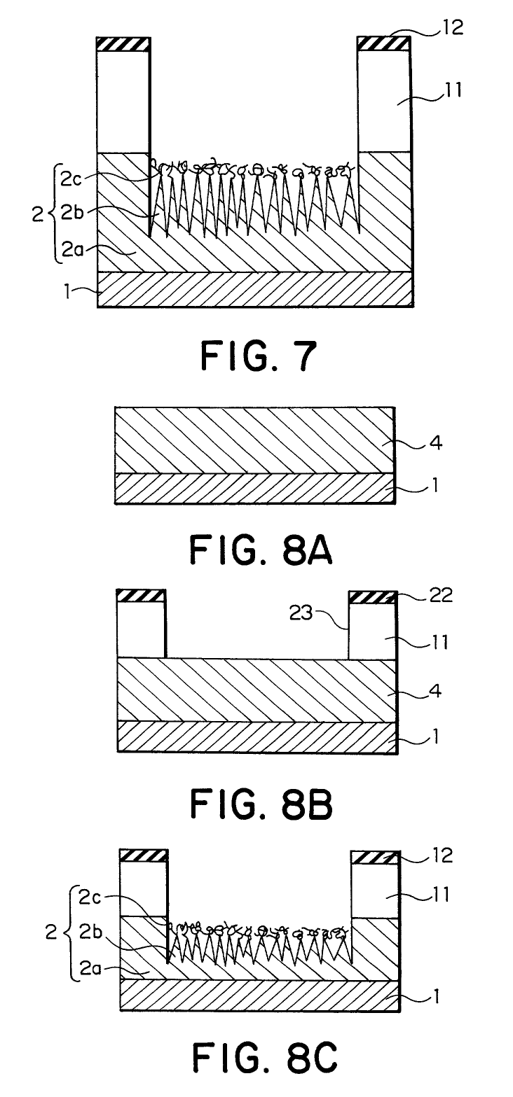

Referring to FIG. 7, a field emission cathode according to a third embodiment of this invention has a carbon film 2 similar in structure to those illustrated in FIGS. 4A to 4D, 5, and 6. The illustrated carbon film 2 is located at a position of the substrate 1 where an emitter is to be formed. The carbon film 2 is surrounded by a uniform carbon layer 2a, on which an insulator film 11 is formed. In addition, a gate electrode 12 is deposited on the insulator film 11 to form the field emission cathode. From this fact, it is readily understood that a plurality of acicular projections serve as a single emitter and are surrounded by a single the gate electrode 12.

Referring to FIGS. 8A, 8B, and 8C, description will be made about a method of manufacturing the field emission cathode. As shown in FIG. 8A, a carbon film 4 is deposited to a thickness of 500 nm on a substrate I by a thermal filament CVD method. In this event, the deposition of the carbon film 4 is executed on deposition conditions that a mixture gas of methane and hydrogen is used as a gas with a concentration rate of methane kept at 1% within the mixture gas. During the deposition of the carbon film 4, a total pressure is kept at 2.66×10³ Pa (20 Torr) while the substrate is held at a temperature of about 850° C.

As shown in FIG. 8B, an insulating film 11 and a gate film 22 are successively deposited on the carbon film 4 to thicknesses of 500 nm and 100 nm, respectively. Subsequently, a gate hole 23 is opened through the insulator film 11 and the gate film 22.

As illustrated in FIG. 8C, an exposed carbon film 4 is subjected to surface processing and, as a result, the surface of the carbon film 4 is rendered into an acicular carbon layer 2b of an acicular projection structure. Such surface processing is carried out about the substrate 1 with the carbon film 4 for one hour by generating ECR plasma of about 500 W. Such ECR plasma is obtained by impressing a magnetic flux density of about 850 and 900 G and a microwave of about 2.5 GHz within a hydrogen gas kept at a pressure between 1.33×10⁻² and 1,33×10⁻¹ Pa (10⁻⁴ and 10³ Torr).

Furthermore, the surface processing is continued under the same conditions within the ECR plasma for about 2 hours. As a result, the filamentous carbon layer 2c is provided which is formed on the surface of the acicular carbon layer 2b by an aggregation of carbon filaments that are very thin and which have diameters of 1 nm or so. The number of the carbon filaments may be equal to unity. At any rate, it is obtained that the carbon film 2 has a triple layer structure, as shown in FIG. 8C.

Herein, it is to be noted that the gate film 22 which is formed around the gate hole 23 may be used as a gate electrode 12. With this structure, the filamentous carbon layer 2c is very useful to provide a great number of emission points which enable emissions at a low voltage. Consequently, the illustrated field emission cathode according to this invention has a high current density.

According to this invention, it is possible to obtain the filamentous carbon layer which is uniformly covered on the acicular carbon layer of the conical or the pyramidal shape. Thus, the filamentous carbon layer facilitates concentrations of electric fields and is formed adjacent to tops of the acicular projections of the acicular carbon layer. With this structure, the number of the emission points can be considerably increased and emissions can be accomplished at a low electric voltage and at a high uniform current density.

According to this invention, the field emission cathode is uniform in the emission characteristic and is operable at a low electric voltage by providing the emitter formed by this invention.

According to the embodiment of this invention, the method can form the very thin filamentous carbon layer by obtaining the acicular carbon layer by plasma processing the carbon layer in the hydrogen gas, by subsequently plasma processing the acicular carbon layer within the hydrogen gas to provide the filamentous carbon layer on the acicular carbon layer. Therefore, it is possible to attain the filamentous carbon layer only by lengthening the plasma processing time due to the hydrogen gas to form the acicular carbon layer.

According to another embodiment of this invention, the method of manufacturing the carbon film, the acicular carbon layer is formed by carrying out the plasma processing in the hydrogen gas and in the oxygen gas. Such plasma processing in the oxygen gas make it possible to change the configuration of the acicular carbon layer. This serves to form the carbon film which has a different emission characteristic.

According to still another embodiment of this invention, there is obtained the method of manufacturing the field emission cathode, which is operable at a low electric voltage and which has a uniform emission characteristic.

While this invention has thus far been described in conjunction with several embodiments thereof, it will readily be possible for those skilled in the art to put this invention into practice in various other manners. For example, the acicular carbon layer 2b and the filamentous carbon layer 2c can be changed in structure and in situation by changing the plasma processing conditions within the hydrogen gas or the plasma processing conditions within the oxygen gas. Moreover, this invention is not restricted to the carbon film of the triple layer structure but may be applicable to a carbon film of a composite layer structure more than the triple layer structure. In addition, this invention can be applied to a filamentous layer of a material that is different from the carbon, if the material has a low work function. In this connection, the film 2 illustrated in FIGS. 2, 7, and 8 may be collectively called a field emission film. Each emitter may be formed by a single one of the acicular projections with the filament or filaments, although each emitter is structured in FIGS. 7 and 8 by the plurality of the acicular projections surrounded by the single gate electrode.

What is claimed is:

1. A carbon film comprising an acicular carbon layer and a filamentous carbon layer which is covered on the acicular carbon layer.

2. A carbon film as claimed in claim 1, wherein the acicular carbon layer comprises a plurality of conical and/or pyramidal shape projections.

3. A carbon film as claimed in claim 2, wherein the projections have bottom widths that are not greater than 200 nm.

4. A carbon film as claimed in claim 1, wherein the filamentous carbon layer is formed by at least one carbon filament that is not greater than 10 nm in filament width.

5. A film for use in emitting electrons, the film comprising a filamentous layer formed by a plurality of filaments.

6. A film as claimed in claim 5, wherein the filamentous layer is attached to an acicular layer.

7. A film as claimed in claim 6, wherein the acicular carbon layer comprises a plurality of acicular projections.

8. A film as claimed in claim 7, wherein the acicular projections have conical and/or pyramidal shapes.

9. A film as claimed in claim 5, wherein the filamentous layer is composed of carbon.

10. A film as claimed in claim 6, wherein both the filamentous layer and the acicular layer are formed by carbon.

11. A field emission cathode comprising an emitter for emitting electrons, wherein the emitter comprises a carbon film which has a composite layer structure.

12. A field emission cathode as claimed in claim 11, wherein the composite layer structure has an acicular carbon layer and a filamentous carbon layer which is covered on the acicular carbon layer.

13. A field emission cathode as claimed in claim 12, wherein the acicular carbon layer comprises a plurality of conical and/or pyramidal shape projections.

14. A field emission cathode as claimed in claim 13, wherein the filamentous carbon layer is formed by at least one carbon filament that is not greater than 10 nm in filament width.

15. A method of manufacturing a composite carbon film, comprising the steps of:
depositing a carbon film;
forming an acicular carbon layer composed of acicular projections on a surface of the carbon film; and
changing the acicular carbon layer into a filamentous carbon layer comprising at least one filament to form the composite carbon film.

16. A method as claimed in claim 15, wherein the forming step comprising the step of:
carrying out plasma processing of the carbon film within a hydrogen gas to form the acicular carbon layer;
the changing step comprising the step of:
carrying out plasma processing the acicular carbon layer within a hydrogen gas to form the filamentous carbon layer attached to the acicular carbon layer and to thereby form the composite carbon film.

17. A method as claimed in claim 15, wherein the forming step comprising the step of:
carrying out plasma processing of the carbon film within a hydrogen gas and an oxygen gas to form the acicular carbon layer;
the changing step comprising the step of:
carrying out plasma processing the acicular carbon layer within a hydrogen gas to form the filamentous carbon layer attached to the acicular carbon layer and to thereby form the composite carbon film.

18. A method of manufacturing a field emission cathode which has an emitter, comprising the steps of:
depositing a carbon film;
forming an acicular carbon layer composed of acicular projections on a surface of the carbon film; and
changing the acicular carbon layer into a filamentous carbon layer comprising at least one filament to form the emitter.

19. A method as claimed in claim 18, wherein the forming step comprising the step of:
carrying out plasma processing of the carbon film within a hydrogen gas to form the acicular carbon layer;
the changing step comprising the step of:
carrying out plasma processing the acicular carbon layer within a hydrogen gas to form the filamentous carbon layer attached to the acicular carbon layer and to thereby form the emitter.

20. A method as claimed in claim 18, wherein the forming step comprising the step of:
carrying out plasma processing of the carbon film within a hydrogen gas and an oxygen gas to form the acicular carbon layer;
the changing step comprising the step of:
carrying out plasma processing the acicular carbon layer within a hydrogen gas to form the filamentous carbon layer attached to the acicular carbon layer and to thereby form the emitter.
